(19) United States
(12) Patent Application Publication
(10) Pub. No.: US 2024/0319916 A1
(43) Pub. Date: Sep. 26, 2024

(54) PHYSICAL INTERFACE CONFIGURATION BUFFER IN A FLASH MEMORY SYSTEM

(71) Applicant: QUALCOMM Incorporated, San Diego, CA (US)

(72) Inventors: Hung Vuong, Coronado, CA (US); Benish Babu, San Diego, CA (US)

(21) Appl. No.: 18/187,259

(22) Filed: Mar. 21, 2023

(51) Int. Cl. G06F 3/06

(52) U.S. Cl. CPC G06F 3/0658; G06F 3/0656; G06F 3/0679; G06F 3/0604

(57) ABSTRACT

This disclosure provides systems, methods, and devices for memory systems that support updating a configuration of a physical layer interface (PHY) using information stored in a buffer of a connected memory system. In a first aspect, a method of accessing data in a flash memory system includes initializing, by a memory controller of a host device, a PHY for connecting the host device to a memory system to operate at a first speed, receiving PHY configuration information for configuring the PHY to operate at a second speed, greater than the first speed, from a first buffer of the memory system, and adjusting, by the memory controller, a configuration of the PHY in accordance with the PHY configuration information to operate at the second speed. Other aspects and features are also claimed and described.

### TECHNICAL FIELD

Aspects of the present disclosure relate generally to an apparatus and method for controlling a memory device. Some aspects may, more particularly, relate to an apparatus and method for controlling operations for updating a physical interface (PHY) configuration using information from a PHY configuration buffer.

### INTRODUCTION

As the value and use of information continues to increase, individuals and businesses seek additional ways to process and store information. In addition, the use of information in various locations and desired portability of information is increasing. For this reason, users are increasingly turning towards the use of portable electronic devices, such as mobile phones, digital cameras, laptop computers and the like. Portable electronic devices generally employ a memory system using a memory device for storing data. A memory system may be used as a main memory or an auxiliary memory of a portable electronic device.

The memory device of the memory system may include one kind or a combination of kinds of storage. For example, magnetic-based memory systems, such as hard disk drives (HDDs), store data by encoding data as a combination of small magnets. As another example, optical-based memory systems, such as digital versatile discs (DVDs) and Blu-ray media, store data by encoding data as physical bits that cause different reflections when illuminated by a light source. As a further example, electronic memory devices store data as collections of electrons that can be detected through voltage and/or current measurements.

Electronic memory devices can be advantageous in certain systems in that they may access data quickly and consume a small amount of power. Examples of an electronic memory device having these advantages include universal serial bus (USB) memory devices (sometimes referred to as “memory sticks”), a memory card (such as used in some cameras and gaming systems), and solid state drive (SSDs) (such as used in laptop computers). NAND flash memory is one kind of memory device that may be used in electronic memory devices. NAND flash memory is manufactured into memory cards or flash disks. Example memory cards include compact flash (CF) cards, multimedia cards (cMMCs), smart media (SM) cards, and secure digital (SD) cards.

A memory system may, in some cases, be integrated with or otherwise connected to an electronic system. For example, a flash memory system, which may be a universal flash storage (UFS) system, may be integrated into an electronic system, such as an access point (AP), station (STA), user equipment (UE), base station, modem, camera, or other system.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A buffer located on a flash memory may be used to store configuration information for patching a PHY to operate at enhance speeds. For example, a PHY connecting a memory system, such as a memory system including a flash memory, to a host device may be configured to operate at a lower speed during initialization of the host device, which may include initialization of the PHY and the memory system. The configuration information stored on the PHY may be accessible during initialization of the host device, such as before initialization of the flash memory is complete. The host device may read the PHY configuration information from the flash memory and may adjust a configuration of the PHY to operate at a higher speed in accordance with the PHY configuration information. Thus, a memory controller of the host device may access the configuration information early in an initialization process to patch the PHY to operate at an enhanced speed. Such enhanced speeds may allow for more rapid initialization of the host device. Furthermore, the buffer may allow for storage of other PHY configuration information to facilitate post-silicon patching of bugs or operating efficiency enhancements of the PHY early in the booting process.

In one aspect of the disclosure, a memory device includes a memory controller coupled to a memory module through a first channel and configured to access data stored in the memory module through the first channel; and coupled to a host device through a first physical interface (PHY) and configured to communicate with the host device over the first interface. The memory controller of the memory device may be configured to perform operations including receiving, from the host device, after the PHY is initialized to operate at a first speed, a request for PHY configuration information for configuring the PHY to operate at a second speed, greater than the first speed, from a first buffer of the memory module and transmitting the PHY configuration information to the host device. In another aspect of the disclosure, a method for performing these operations by a processor by executing instructions stored in a memory coupled to the processor is also disclosed. In an additional aspect of the disclosure, a non-transitory computer-readable medium stores instructions that, when executed by a processor, cause the processor to perform these operations.

In an additional aspect of the disclosure, an apparatus includes a memory controller of a host device configured to couple the host device to a memory system through a first physical interface (PHY), the memory controller configured to perform operations including initializing the PHY to operate at a first speed, receiving PHY configuration information for configuring the PHY to operate at a second speed, greater than the first speed, from a first buffer of the memory system, and adjusting a configuration of the PHY in accordance with the PHY configuration information to operate at the second speed. In another aspect of the disclosure, a method for performing these operations by a processor by executing instructions stored in a memory coupled to the processor is also disclosed. In an additional aspect of the disclosure, a non-transitory computer-readable medium stores instructions that, when executed by a processor, cause the processor to perform these operations.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a data processing system including a memory system in accordance with an embodiment of the present invention.

FIG. 2 is a block diagram illustrating an example electronic device including the memory system according to one or more aspects of the disclosure.

FIG. 3 is a block diagram illustrating components for facilitating access to a flash memory device from a host device according to some embodiments of the disclosure.

FIG. 4A is a timing flow diagram illustrating an initialization process for a host device according to some embodiments of the disclosure.

FIG. 4B is a timing flow diagram illustrating an initialization process for a host device according to some embodiments of the disclosure.

FIG. 5 is a flow chart illustrating a method for initialization of a host device according to some embodiments of the disclosure.

FIG. 6 is a flow chart illustrating a method for initialization of a host device using PHY configuration information stored in a flash buffer according to some embodiments of the disclosure.

FIG. 7 is flow chart illustrating a method for initialization of a host device using PHY configuration information stored in a flash buffer by a host controller according to some embodiments of the disclosure.

FIG. 8 is a flow chart illustrating a method for initialization of a host device using PHY configuration information stored in a flash buffer by a flash memory device according to some embodiments of the disclosure.

FIG. 9 is a block diagram illustrating details of an example wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques for storing, retrieving, and organizing data in a memory system. Aspects of this disclosure provide for operations and data structures used in those operations for patching a PHY connecting a host device to a memory system to operate at a higher speed using PHY configuration information stored in a buffer of a memory of the memory subsystem.

Particular implementations of the subject matter described in this disclosure may be implemented to realize one or more of the following potential advantages or benefits. In some aspects, the present disclosure provides techniques for improved performance of a memory system, such as enhanced speed during a booting process of a host device and reduced boot time. Enhanced speed during booting and reduced boot times may be particularly advantageous in the context of automotive computer systems, where boot times less than 50 mS may be desirable.

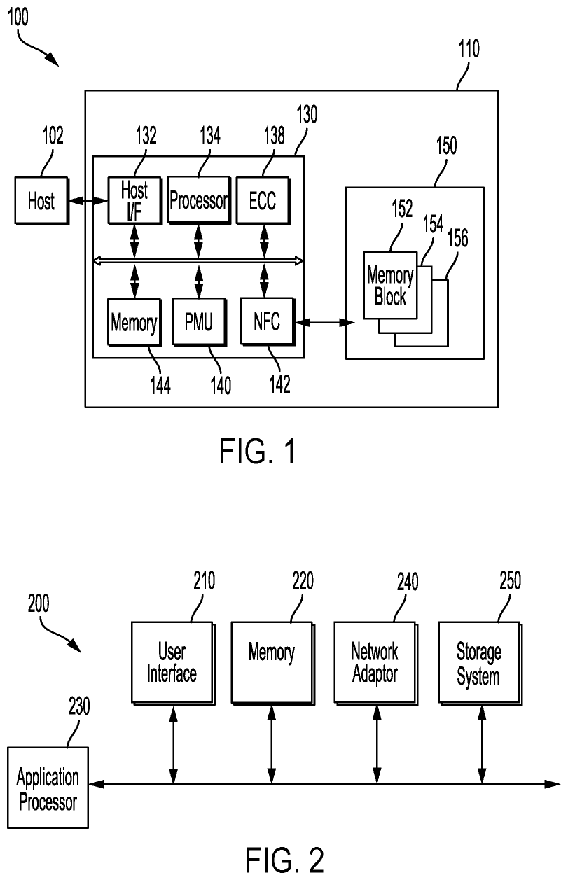

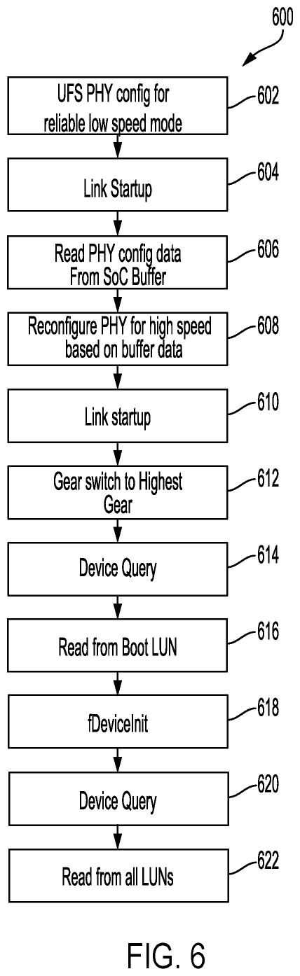

Memory may be used in a computing system organized as illustrated in FIG. 1. FIG. 1 illustrates a data processing system 100, such as may be included in a mobile computing device, according to one or more aspects of the disclosure. A memory system 110 may couple to a host device 102 through one or more channels. For example, the host device 102 and memory system 110 may be coupled through a serial interface including a single channel for the transport of data or a parallel interface including two or more channels for the transport of data. In some aspects, control data may be transferred through the same channel(s) as the data or the control data may be transferred through additional channels. The host device 102 may be, for example, a portable electronic device such as a mobile phone, an MP3 player, a laptop computer, or a non-portable electronic device such as a desktop computer, a game player, a television (TV), a media player, or a projector. As another example, the host device 102 may be an automotive computer system. Additional example host devices are illustrated and described with reference to FIG. 6.

The memory system 110 may execute operations in response to commands (e.g., a request) from the host device 102. For example, the memory system 110 may store data provided by the host device 102 and the memory system 110 may also provide stored data to the host device 102. The memory system 110 may be used as a main memory, short-term memory, or long-term memory by the host device 102. As one example of main memory, the host device 102 may use the memory system 110 to supplement or replace a system memory by using the memory system 110 to store temporary data such as data relating to operating systems and/or threads executing in the operation system. As one example of short-term memory, the host device 102 may use the memory system 110 to store a page file for an operating system. As one example of long-term memory, the host device 102 may use the memory system 110 to store user files (e.g., documents, videos, pictures) and/or application files (e.g., word processing executable, gaming application).

The memory system 110 may be implemented with any one of various storage devices, according to the protocol of a host interface for the one or more channels coupling the memory system 110 to the host device 102. The memory system 110 may be implemented with any one of various storage devices, such as a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The memory system 110 may include a memory module 150 and a controller 130 coupled to the memory module 150 through one or more channels. The memory module 150 may store and retrieve data in memory blocks 152, 154, and 156 under control of the controller 130, which may execute commands received from the host device 102. The controller 130 is configured to control data exchange between the memory module 150 and the host device 102. The storage components, such as blocks 152, 154, and 156 in the memory module 150 may be implemented as volatile memory device, such as, a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a NAND flash memory.

The controller 130 and the memory module 150 may be formed as integrated circuits on one or more semiconductor dies (or other substrate). In some aspects, the controller 130 and the memory module 150 may be integrated into one chip. In some aspects, the memory module 150 may include one or more chips coupled in series or parallel with each other and coupled to the controller 130, which is on a separate chip. In some aspects, the memory module 150 and controller 130 chips are integrated in a single package, such as in a package on package (POP) system. In some aspects, the memory system 110 is integrated on a single chip with one or more or all of the components (e.g., application processor, system memory, digital signal processor, modem, graphics processor unit, memory interface, input/output interface, network adaptor) of the host device 102, such as in a system on chip (SoC). The controller 130 and the memory module 150 may be integrated into one semiconductor device to form a memory card, such as, for example, a Personal Computer Memory Card International Association (PCMCIA) card, a compact flash (CF) card, a smart media card (SMC), a memory stick, a multimedia card (MMC), an RS-MMC, a micro-MMC, a secure digital (SD) card, a mini-SD, a micro-SD, an SDHC, and a universal flash storage (UFS) device.

The controller 130 of the memory system 110 may control the memory module 150 in response to commands from the host device 102. The controller 130 may execute read commands to provide the data from the memory module 150 to the host device 102. The controller 130 may execute write commands to store data provided from the host device 102 into the memory module 150. The controller 130 may execute other commands to manage data in the memory module 150, such as program and erase commands. The controller 130 may also execute other commands to manage control of the memory system 110, such as setting configuration registers of the memory system 110. By executing commands in accordance with the configuration specified in the configuration registers, the controller 130 may control operations of the memory module 150, such as read, write, program, and erase operations.

The controller 130 may include several components configured for performing the received commands. For example, the controller 130 may include a host interface (I/F) unit 132, a processor 134, an error correction code (ECC) unit 138, a power management unit (PMU) 140, a NAND flash controller (NFC) 142, and/or a memory 144. The power management unit (PMU) 140 may provide and manage power for components within the controller 130 and/or the memory module 150.

The host interface unit 132 may process commands and data provided from the host device 102, and may communicate with the host device 102, through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). For example, the host interface 132 may be a parallel interface such as an MMC interface, or a serial interface such as an ultra-high speed class 1 (UHS-I)/UHS class 2 (UHS-II) or a universal flash storage (UFS) interface.

The ECC unit 138 may detect and correct errors in the data read from the memory module 150 during the read operation. The ECC unit 138 may not correct error bits when the number of the error bits is greater than a threshold number of correctable error bits, which may result in the ECC unit 138 outputting an error correction fail signal indicating failure in correcting the error bits. In some aspects, no ECC unit 138 may be provided or the ECC unit 138 may be configurable to be active for some or all of the memory module 150. The ECC unit 138 may perform an error correction operation using a coded modulation such as a low-density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), or a Block coded modulation (BCM).

The NFC 142 provides an interface between the controller 130 and the memory module 150 to allow the controller 130 to control the memory module 150 in response to a commands received from the host device 102. The NFC 142 may generate control signals for the memory module 150, such as signals for rowlines and bitlines, and process data under the control of the processor 134. Although NFC 142 is described as a NAND flash controller, other controllers may perform similar function for other memory types used as memory module 150.

The memory 144 may serve as a working memory of the memory system 110 and the controller 130. The memory 144 may store data for driving the memory system 110 and the controller 130. When the controller 130 controls an operation of the memory module 150 such as, for example, a read, write, program or erase operation, the memory 144 may store data which are used by the controller 130 and the memory module 150 for the operation. The memory 144 may be implemented with a volatile memory such as, for example, a static random access memory (SRAM) or a dynamic random access memory (DRAM). In some aspects, the memory 144 may store address mappings, a program memory, a data memory, a write buffer, a read buffer, a map buffer, and the like.

The processor 134 may control the general operations of the memory system 110, and a write operation or a read operation for the memory module 150, in response to a write request or a read request received from the host device 102, respectively. For example, the processor 134 may execute firmware, which may be referred to as a flash translation layer (FTL), to control the general operations of the memory system 110. The processor 134 may be implemented, for example, with a microprocessor or a central processing unit (CPU), or an application-specific integrated circuit (ASIC).

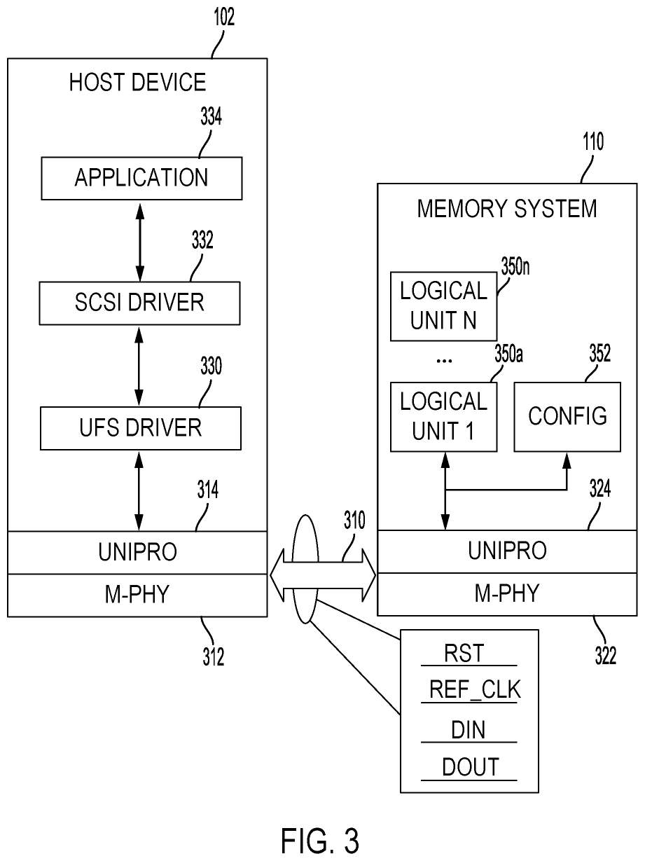

FIG. 2 is a block diagram illustrating an example electronic device including the memory system 100 according to one or more aspects of the disclosure. The electronic device 200 may include a user interface 210, a memory 220, an application processor 230, a network adaptor 240, and a storage system 250 (which may be one embodiment of the memory system 100 of FIG. 1). The application processor 230 may be coupled to the other components through a bus, such as a peripheral component interface (PCI) bus, including a PCI express (PCIe) bus.

The application processor 230 may execute computer program code, including applications, drivers, and operating systems, to coordinate performing of tasks by components included in the electronic device 200. For example, the application processor 230 may execute a storage driver for accessing the storage system 250. The application processor 230 may be part of a system-on-chip (SoC) that includes one or more other components shown in electronic device 200.

The memory 220 may operate as a main memory, a working memory, a buffer memory or a cache memory of the electronic device 200. The memory 220 may include a volatile random access memory such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDRAM, an LPDDR2 SDRAM, an LPDDR3 SDRAM, an LPDDR4 SDRAM, an LPDDR5 SDRAM, or an LPDDR6 SDRAM, or a nonvolatile random access memory such as a phase change random access memory (PRAM), a resistive random access memory (ReRAM), a magnetic random access memory (MRAM) and a ferroelectric random access memory (FRAM). In some aspects, the application processor 230 and the memory 220 may be combined using a package-on-package (POP).

The network adaptor 240 may communicate with external devices. For example, the network adaptor 240 may support wired communications and/or various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (Wi-Di), and so on, and may thereby communicate with wired and/or wireless electronic appliances, for example, a mobile electronic appliance.

The storage system 250 may store data, for example, data received from the application processor 230, and transmit data stored therein, to the application processor 230. The storage system 250 may be a non-volatile semiconductor memory device, such as a phase-change RAM (PRAM), a magnetic RAM (MRAM), a resistive RAM (ReRAM), a NAND flash memory, a NOR flash memory, or a 3-dimensional (3-D) NAND flash memory. The storage system 250 may be a removable storage medium, such as a memory card or an external drive. For example, the storage system 250 may correspond to the memory system 110 described above with reference to FIG. 1 and may be a SSD, eMMC, UFS, or other flash memory system.

The user interface 210 provide one or more graphical user interfaces (GUIs) for inputting data or commands to the application processor 230 or for outputting data to an external device. For example, the user interface 210 may include user input interfaces, such as a virtual keyboard, a touch screen, a camera, a microphone, a gyroscope sensor, or a vibration sensor, and user output interfaces, such as a liquid crystal display (LCD), an organic light emitting diode (OLED) display device, an active matrix OLED (AMOLED) display device, a light emitting diode (LED), a speaker, or a haptic motor.

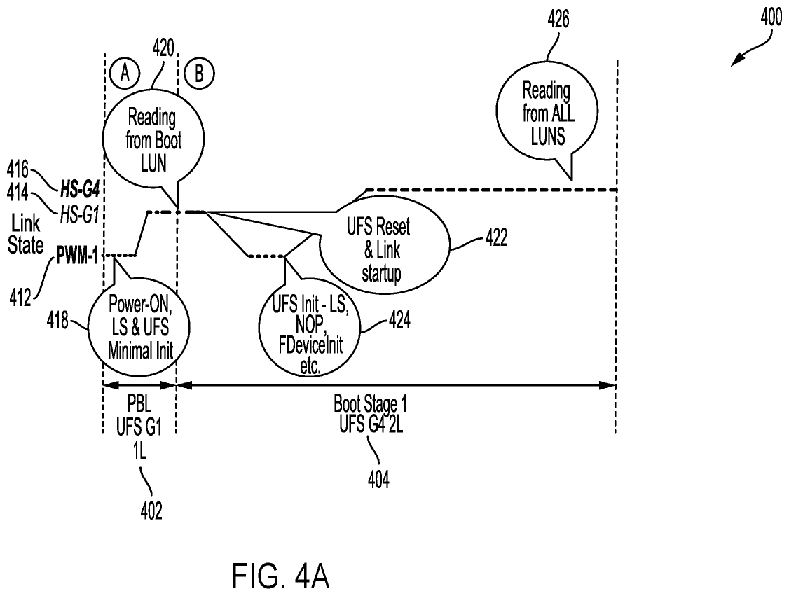

FIG. 3 is a block diagram illustrating components for facilitating access to a flash memory system from a host device according to some embodiments of the disclosure. The host device 102 accesses the memory system 110 through the first interface 310. The first interface may, for example, be a physical interface (PHY). The host device 102 may include physical layer access block 312, which is configured to generate signals for output to the first interface 310 and process signals received through the first interface 310. The memory system 110 includes a similarly-configured physical layer access block 322 for communicating on the first interface 310. One example physical layer specification for communicating on the first interface 310 is the MIPI M-PHY™ physical layer specification.

The host device 102 also includes a data link layer block 314 configured to format frames of data for transmission on the first interface 310. The frames may be provided to the physical layer access block 312 for transmission. The data link layer block 314 may receive frames from the physical layer access block 312 and decode frames of data received on the first interface 310. The memory system 110 includes a similarly-configured data link layer block 324 for processing frames transmitted on or received on the first interface 310 by the physical layer access block 322. One example data link protocol for communicating on a MIPI M-PHY™ physical link is the MIPI UNIPRO™ specification.

The memory system 110 includes N logical units 350a-n comprising logical memory blocks for storing information including user data (e.g., user documents, application data) and configuration data (e.g., information regarding operation of the memory system 110). The logical units 350a-n may map to portions of the physical memory blocks 152, 154, and 156. Some of the logical units 350a-n or portions of the logical units 350a-n may be configured with write protection, with boot capability, as a specific memory type (e.g., default, system code, non-persistent, enhanced), with priority access, or with replay protection as a replay protected memory block (RPMB). The physical layer access block 322 and the data link layer block 324 perform operations of a memory controller for the memory system 110 for storing and retrieving data in logical units 350a-n. As one particular example, one or more logical units of logical units 350a-n may be configured as a buffer for storage of PHY configuration information as described herein, such as one or more patches for configuring the interface 310 to operate at different speeds. The logical units of the buffer may be configured to be accessible before the memory system 110 is fully initialized, such as before an fDeviceInit operation for the memory system is complete, to allow a speed of communication across the interface 310 to be increased early in a booting process of the host device 102. An fDeviceInit operation may be an initialization operation for the memory system. In some embodiments, an fDeviceInit flag may be set at the beginning of an initialization operation for a UFS memory system and may be reset when the initialization of the memory system is complete. In some embodiments, the logical units of the buffer may be locked or configured as read-only to prevent alteration of the PHY configuration information.

The memory system 110 also includes configuration structures 352. The configuration structures 352 may include information such as configuration descriptors for boot enable (bBootEnable), initial power mode (bInitPowerMode), RPMB active (bRPMBRegionEnable), and/or RPMB region sizes (bRPMBRegion1Size, bRPMBRegion2Size, bRPMBRegion3Size). Such configuration structures may, for example, be specified by the UFS standard.

The host device 102 may be configured to execute one or more applications 334, such as user applications executed by an operating system under the control of a user to receive user input and provide information stored in the memory system 110 to the user. The host device 102 may include several components for interfacing the application 334 to the memory system 110 through the first interface 310. For example, a SCSI driver 332 and a UFS driver 330 may interface the application 334 to a host memory controller that includes the data link layer block 314 and the physical layer access block 312. The SCSI driver 332 may execute at an application layer for handling transactions requested by the application 334 with the memory system 110. The UFS driver 330 may execute at a transport layer and manage operation of the data link layer block 314, such as to operate the first interface 310 at one of a plurality of modes of operations. The modes of operations may include two or more gear settings, such as one or more PWM-GEAR settings and four or more HS-GEAR settings specifying one bitrate from 182 MBps, 364 MBps, 728 MBps, and 1457 MBps.

The first interface 310 may include one or more lines including a reset RST line, a reference clock REF_CLK line, a data-in DIN line (for data transmissions from the host device 102 to the memory system 110), and a data-out DOUT line (for data transmissions from the memory system 110 to the host device 102). The DIN and DOUT lines may be two separate conductors, or the DIN and DOUT lines may include multiple conductors. In some embodiments, the DIN and DOUT lines may be asymmetric with the DIN line including N conductors and the DOUT line including M conductors, with N>M or M>N.

The UFS driver 330 may generate and decode packets to carry out transactions requested by the application 334. The packets are transmitted over the first interface 310. The packets may be formatted as UFS Protocol Information Units (UPIUs). In a transaction with the memory system 110, the host device 102 is an initiator and the memory system 110 is a target. The UFS driver 330, based on the type of transaction, may form one of several types of UPIUs for handling SCSI commands, data operations, task management operations, and/or query operations. Each transaction may include one command UPIU, zero or more DATA IN or DATA OUT UPIUs, and a response UPIU. Each UPIU may include a header followed by optional fields depending on the type of UPIU.

One example transaction is a read operation. A read transaction may include the initiator (e.g., host device 102) transmitting a command UPIU for causing the target (e.g., memory system 110) to perform a read operation requested by the application 334. The target provides one or more DATA IN UPIUs in response to the command UPIU, in which the DATA IN UPIUs include the requested data. The read transaction is completed by the target transmitting a Response UPIU.

Another example transaction is a write operation. A write operation may include the initiator (e.g., host device 102) transmitting a command UPIU for causing the target (e.g., memory system 110) to perform a write operation requested by the application 334. The target provides a Ready to Transfer UPIU signaling the initiator to begin transfer of write data. The initiator then transmits one or more DATA OUT UPIUs, which are followed by a Ready to Transfer UPIU signaling the initiator to continue transfer of the write data. The sequence of DATA OUT UPIUs and Ready to Transfer UPIU continues until all write data is provided to the target, after which the target provides a Response UPIU to the initiator.

A further example transaction is a query operation. A query operation may include the initiator (e.g., host device 102) requesting information about the target (e.g., memory system 110). The initiator may transmit a Query Request UPIU to request information such as configuration, enumeration, device descriptor, flags, and/or attributes of the target. Example query operations includes read descriptor, write descriptor, read attribute, write attribute, read flag, set flag, clear flag, and/or toggle flag. Example descriptors include device, configuration, unit, interconnect, string, geometry, power, and/or device health. Example flags include fDeviceInit, fPermanenetWPEn, fPowerOn WPEn, fBackgroundOpsEn, fDevice LifeSpanModeEn, fPurgeEnable, fRefreshEnable, fPhyResourceRemoval, fBusyRTC, and/or fPermanentlyDisableFwUpdate. Example attributes include bBootLunEn, bCurrentPowerMode, bActiveICCLevel, bOutOfORderDataEn, bBackgroundOpStatus, bPurgeStatus, bMaxDataInSize, bMaxDataOutSize, dDynCapNeeded, bRefClkFreq. Such flags may, for example, be flags specified by the UFS standard.

The operations and capabilities described above may be used for a memory system that supports adjusting a configuration of a PHY in accordance with PHY configuration information stored in a memory of a memory system connected to a host device by the PHY to enable enhanced communication speeds via the PHY. Use of a buffer of a memory of the memory system to store the PHY configuration information may allow a PHY configuration to be updated prior to completion of an initialization process of the host device, such as before initialization of the memory on which the buffer is located is complete, such that the PHY configuration information is retrieved from the memory before the memory is fully initialized.

As described herein, a host device may be connected to a memory system, such as a UFS flash memory system, via a PHY. In some cases, the host device, the memory system, and the PHY may be integrated in a single SoC. During initialization, or booting, of the host device, the PHY may be configured to operate at different speeds during different parts of the initialization process. In some systems, such as systems where a host device is connected to a UFS or NVMe memory system, initialization may require a substantial amount of time, such as between 34 and 150 mS, due to initialization of the PHY connecting the host device to the memory system, link startup requirements, such as link initialization and negotiation between the host device and the memory system, and initialization of firmware, such as preparation of logical to physical (L2P) tables and other background activities for the host device and/or memory system. Initialization times may vary based on vendor and device types. In particular, different devices manufactured by different vendors may require different amounts of time for different initialization stages and operations, such as link startup, no-operation messaging (NOP), fDeviceInit, and other operations. Initialization times may be impacted by PHY initialization times, link startup times, slow PHY operating speeds when reading from boot ROM, and multiple UFS initialization processes performed during the initialization process. In some use cases, such as automotive use cases, a reduced initialization time, such as an initialization time of less than 50 ms may be desirable.

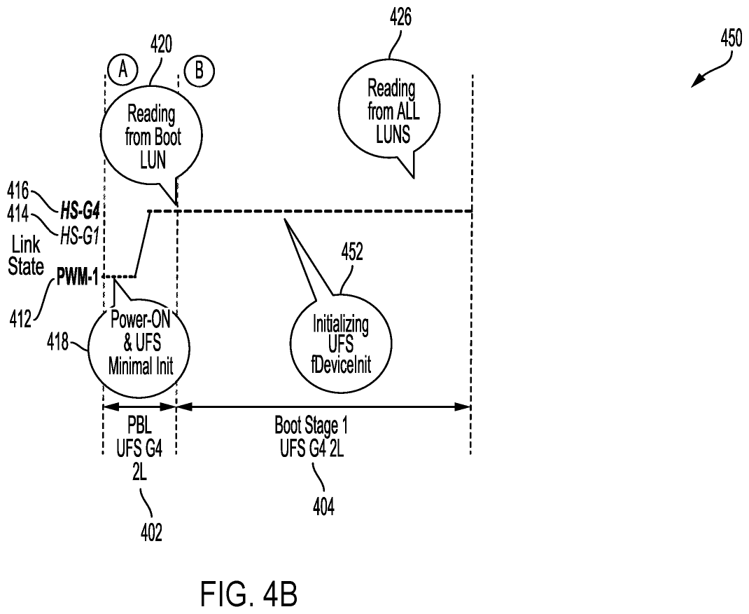

During initialization of a host device, a PHY connecting the host device to a memory system may operate at different link speeds at different times. Such initialization may include initialization of the PHY connecting the host device to the memory system, initialization of the host device, and initialization of the memory system. Increasing a speed at which the PHY is configured to operate during one or more times of the initialization process may reduce an amount of time required for the initialization process. An example initialization process 400 may include initialization of the PHY, the memory system, and other systems and/or devices. The initialization process 400, which may also be referred to as a boot process, may be divided into a plurality of stages, as shown in FIG. 4A. At a first stage 402, which may be a pre-boot loader (PBL) stage, a PBL may configure the PHY to operate at a lower speed, such as a high speed gear one (HS-G1) speed. For example, the PHY may be configured by the PBL, at the first stage 402, to operate at the HS-G1 speed to minimize post-silicon changes to the PHY, which may require PBL patching. At a start of the first stage 402, the PHY may be configured to operate at a pulse width modulation 1 (PWM-1) speed, which may be slower than an HS-G1 speed. At operation 418, the host device, the PHY, and the memory system may be powered on and initialized to operate at a low speed, such as PWM-1. For example, such operations may include a power-on reset, a hardware reset, and an end point reset. After such resets are performed, there may be no active tasks in the device UFS descriptors, and attributes and flags may be set to their default values. Furthermore, UniPro attributes may be reset. The memory system may be minimally initialized to allow the memory system to begin to communicate with the host device via the PHY, and a link startup procedure may be performed. Such a link startup procedure may initialize an earliest link between the host device and the memory system via the PHY. When the operation 418 is complete, a speed of the PHY may increase to an HS-G1 speed. At operation 420, the host device may read from one or more boot look-up numbers (LUNs). At a second stage 404, a full reinitialization of the memory system may be performed, and an operating speed of the PHY may be increased to a high speed gear 4 (HS-G4) speed. For example, at operation 422, the memory system, which may be a UFS memory system, and PHY may be reset and a link startup procedure may be performed. After the reset, a speed of the PHY may be reduced to a PWM-1 speed until, at operation 424, the UFS is reinitialized, a NOP OUT is transmitted by the host device, a NOP IN is received by the host device, and a memory system initialization stage, such as fDeviceInit, is completed. After the operation 424 is complete, the PHY may be configured to operate at an HS-G4 speed, where the PHY may, at operation 426, read from all LUNs of the memory system. . Speeds, such as PWM-1, HS-G1, HS-G2, HS-G3, and HS-G4 may, for example, be speeds specified by the UFS standard.

During initialization process 400, multiple resets and initializations of the memory system may be performed. For example, a first reset and initialization during the first stage 402 and a second reset and initialization during the second stage 404. Such resets and associated initialization and link startup operations may contribute substantially to an initialization time. For example, link startups associated with resets may contribute up to and exceeding 80 mS of an initialization time, with each link startup adding 20-30 mS to the initialization time. Furthermore, during later booting stages, a full re-initialization may be performed on the PHY and memory system, including configuration of the PHY to operate at a HS-G4 speed, a link startup procedure, an fDeviceInit procedure, and other startup operations. The link startup performed at operation 422 may invalidate and/or reset any initialization performed by the memory system prior to operation 422.

In order to reduce an initialization time, such as a boot time, a host device may perform one initialization of the memory system and PHY during the initialization procedure. However, to allow the PHY to be initialized to operate at a higher speed during the PBL stage 402, PHY configuration information stored in a memory, such as a flash memory, of the memory system may be used to patch the PHY for operation at a higher speed, such as an HS-G4 speed. For example, one or more of the link startup and initialization procedures for the memory system may be eliminated, with a PHY and link startup procedure being performed only once during an entire initialization procedure. In some cases, two link startups and one device initialization procedure may be eliminated. Elimination of one or more re-initialization procedures for the PHY and/or memory system may reduce an initialization time by up to or exceeding 70 mS. Furthermore, the memory system may be configured to complete initialization in the background during the second stage 404 and subsequent stages which may allow for skipping one or more NOP and fDeviceInit operations performed during the second initialization stage 404. The PHY may also be initialized, during a PBL stage, to operate at a higher speed, such as HS-G4 instead of HS-G1, further reducing initialization time. For example, as shown in the process 450 of FIG. 4B, a speed of the PHY may be increased from a speed of PWM-1 at a beginning of the first stage 402 of the initialization process to a speed of HS-G4. The host device may read from the boot LUN at 420 at a speed of HS-G4, rather than HS-G1, as shown in FIG. 4A. Furthermore, operation 422 may be bypassed, and operation 452 may include full initialization of the memory system including an fDeviceInit operation while the PHY remains configured to operate at the speed of HS-G4 through the second stage 404 and subsequent stages.

Configuration of a PHY to operate at a high speed early in the boot process, such as a speed greater than HS-G1, may include updating a configuration of the PHY. Such updating may pose challenges due to limitations on post-silicon updates to PHY firmware and PBL ROM patching. Configuring the PHY to operate at a high speed early in the booting process, such as during the PBL stage 402, may increase a risk of PBL patching requirements due to post-silicon PHY characterization and may also increase a risk of post-silicon PHY changes due to customer board-specific adjustments. Enabling updating of a PHY configuration to facilitate PHY operation at speeds greater than HS-G1 during the PBL stage 402 may include use of additional PBL patch space allocation to support such patching and to support UFS PHY updates that may be produced following post-silicon characterization. Such an additional PBL patch space may increase a cost of a SoC including the host device, the PHY, and the memory system. Such issues may be ameliorated, however, through use of a buffer located on a memory, such as a flash memory, of the memory system for storage of PHY configuration information, such as one or more PHY patches, for updating the PHY to operate at a greater speed. For example, a PHY may be patched using PHY configuration information stored in a buffer of a memory of the memory system that is accessible early in the initialization process, such as after performance of a minimal initialization of the memory system at operation 418, and before initialization of the memory system is complete, such as before an fDeviceInit operation at 452 is complete. Updating a configuration of the PHY to operate at enhanced speeds early in an initialization process may reduce an amount of time required for completion of the initialization process. For example, in the process 400 of FIG. 4A, the PHY may be configured to operate at an HS-G1 speed during the PBL stage 402, while in the process 450 of FIG. 4B, the PHY may be configured to operate at an HS-G4, or other, higher, speed during the PBL stage 402. A speed at which the PHY may be reconfigured to operate may be limited by a version of the UFS specification supported by the PHY. For example, if the PHY supports UFS 2.x, a maximum speed of high speed gear three (HS-G3), Rate B, 2L may be supported, if the PHY supports UFS 3.1, a speed of HS-G4, Rate B, 2L may be supported, and if the PHY supports UFS 4.0, a speed of high speed gear five (HS-G5), Rate B. 2L may be supported.

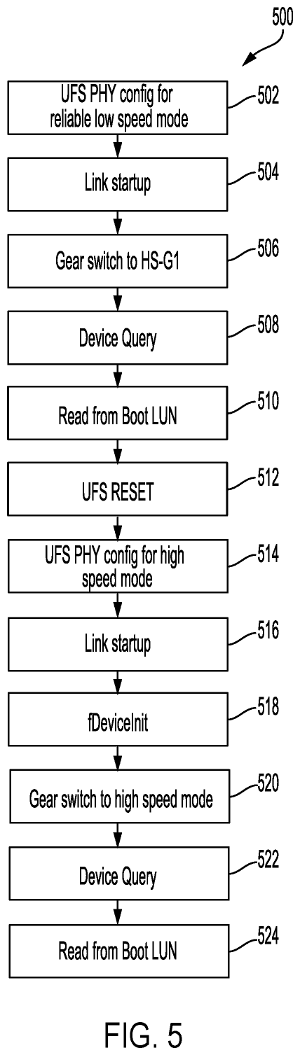

As one particular example, FIG. 5 is a flow chart illustrating an example initialization process, which may be similar to the initialization process 400 of FIG. 4A. In some embodiments, the steps of the method 500 may be performed by a host device connected to a memory system by a PHY. In some embodiments, one or more of the steps may be performed by the PHY and/or the memory system. The method 500 may include, at block 502, configuring a PHY connecting a host device to a memory system to operate at a first speed, such as a highly reliable speed mode. Such a speed mode may, for example, be an HS-G1 speed. Such configuration may be performed by a PBL of the host device.

At block 504, a first link startup may be performed. For example, a link between the host device and the memory system may be initialized. During such a stage, the PHY may operate at a PWM-1 speed. Such a link startup may include transmitting a NOP OUT message to a controller of the memory system and receiving a NOP IN message from the controller of the memory system.

At block 506, a gear switch may be performed for the PHY to operate at an HS-G1 speed. Such a gear switch may, for example, be performed based on the configuration of block 502.

At block 508, a device query may be transmitted from the host device and received by the memory system, and the host device may receive a response from the memory system. The response may, for example, include information regarding the memory system, such as a class of the memory system, a boot process configuration of the memory system, one or more LUNs of the memory system at which booting information is stored, a boot sequence ID, and other information for initialization of the host device, the PHY, and the memory system.

At block 510, the host device may read information from one or more boot LUNs. Such information may, for example, include boot code for initialization of the host device, the PHY, and/or the memory system. In particular, the host device may transmit one or more small computer system interface (SCSI) READ requests to the memory system to read boot code from a boot well known logical unit.

At block 512, a UFS reset may be performed on the memory system. For example, the host device may fully reset the memory system to facilitate configuration of the PHY to operate at a higher speed.

At block 514, the PHY may be configured to operate at an increased speed, such as in a high speed mode. For example, the PHY may be configured to operate in a highest speed mode, such as an HS-G4 speed. Such configuration may, for example, be performed by software.

At block 516, a link startup procedure may be performed. The link startup procedure of block 516 may, for example, be a second or third link startup procedure of an initialization process.

At block 518, a fDeviceInit operation may be performed to complete initialization of the memory system.

At block 520, a gear switch for the PHY to operate in a high speed mode, such as in an HS-G4 speed mode may be performed. In some embodiments, such configuration may include configuration to operate in a highest speed mode supported by the memory system. For example, a speed of operation of the PHY may increase from PWM-1 to HS-G4.

At block 522, a device query may be transmitted from the host device and received by the memory system, and the host device may receive a response from the memory system. Such operations may be similar to the operations described at block 508.

At block 524, the host device may read information from one or more boot LUNs.

Use of PHY configuration information from a buffer of a memory of the memory system may, however, allow for a reduction in boot time by allowing for configuration of the PHY to operate at a higher speed early in the boot process and by allowing for bypassing of one or more reset, initialization, and link startup operations. For example, the operations of blocks 512-516 of the method 500 may be bypassed through use of such configuration information. An example method 600 including use of PHY configuration information stored in a buffer of a memory system connected to a host device by the PHY to increase a speed of the PHY early in the booting process is shown in FIG. 6. The method 600 may include, at block 602, configuring a PHY connecting a host device to a memory system to operate at a first speed, such as to operate in a reliable low speed mode. The first speed may, for example, be an HS-G1 or a PWM-1 speed. Such configuration may be performed by a PBL of the host device to allow the host device to read from a buffer, such as from a SoC buffer, storing PHY configuration information.

At block 604, a link startup may be performed. For example, a link between the host device and the memory system may be initialized. During such a stage, the PHY may operate at a PWM-1 speed. The link startup of block 604 may, for example, be the only link startup procedure performed during the method 600, where multiple link startup procedures may be performed in the method 500.

At block 606, the host device may read PHY configuration information from a buffer, such as a buffer of the memory system. As described, herein, PHY configuration information may include one or more patches for patching a PHY. The PHY configuration information may, for example, include instructions for patching the PHY to operate at a greater speed. In some embodiments, the PHY configuration information may include information identifying a timing of application of a patch to the PHY, a clock speed of the PHY, and other information for configuring the PHY. The PHY configuration information may, for example, be transferred from the memory system to the host device by the PHY while the PHY is operating at a speed of PWM-1 or HS-G1. The buffer may, in some embodiments, be a SoC buffer. In some embodiments, the buffer may be located in an original equipment manufacturer (OEM) customization data region of a memory. For example, the buffer may be located in a data region of a configuration descriptor field to allow the host device to program and/or lock any host-specific data. Thus, the buffer may be located in a read-only memory of the host device. The host device may be able to access such data with minimal latency early during initialization of the memory device, such as early in a PBL initialization stage. For example, in some embodiments, such data may be accessible within 5 mS of a beginning of an initialization process. For example, such data may be accessible by the host device before the host device begins reading from one or more boot LUNs of the memory system. Such data may, however, be protected to prevent modification after the device leaves the factory, and thus such a region may be marked as read-only. Storage of the PHY configuration data in a buffer of read-only memory of the host device may, however, require an increased amount of read-only memory, which may increase device cost.

As another example, the buffer may be located in a non-volatile memory, such as a flash memory, of the memory system. The buffer may be labeled as SoC_BUFFER. The data stored in the buffer may be accessible at any time after an RST_n function is performed early in a booting process. The buffer may be available for writing of PHY configuration information, such as for writing of one or more PHY patches, during a device provisioning phase using a WRITE BUFFER command. The buffer may be subsequently locked using a bConfigDescrLock command, which may render the buffer read only. Such a buffer may provide low latency access to the PHY configuration information. In some embodiments, the latency of such a buffer may be less than a latency of a buffer stored in NAND memory. As one particular example, the host may determine that a PHY configuration buffer in a memory of the memory system is supported when a MODE variable is set to 02h and a buffer ID is set to F0h. The PHY configuration information may be read from the buffer by the host device using a READ BUFFER command during initialization. In some embodiments, the PHY configuration information may be read from the buffer by the host device before initialization of the memory system, such as initialization of the flash memory on which the buffer is located, is complete. The PHY configuration information stored in the buffer may include information for adjusting a configuration of the PHY to operate at a higher speed. For example, the PHY configuration information may include information for patching the PHY to operate at a highest speed supported by a UFS version of the memory system. In some embodiments, the buffer may include a library of PHY patches for different maximum PHY speeds, and a PHY patch may be selected based on a UFS version of the memory system. In some embodiments, the buffer label, commands, and functions may be labels, functions, and commands identified by the UFS standard.

At block 608, the PHY may be configured to operate at a second, higher speed, based on PHY configuration information. For example, a configuration of the PHY may be updated based on the PHY configuration information stored in the buffer, such as the SoC buffer. For example, a configuration of the PHY may be updated to adjust a speed of the PHY from a first, slower, speed, such as PWM-1 or HS-G1, to a higher speed, such as high speed gear 2 (HS-G2), HS-G3, HS-G4, HS-G5, or another higher speed. Such adjustment may, for example, include applying a patch to the PHY.

At block 610, a second link startup procedure may be performed. For example, a link between the host device and the memory system via the PHY may be re-established.

At block 612, a gear switch may be performed on the PHY and the PHY may begin to operate at the higher speed supported by the adjustment to the PHY configuration. For example, the PHY may begin to operate at a speed of HS-G2, HS-G3, HS-G4, HS-G5.

At block 614, a device query may be transmitted from the host device and received by the memory system, and the host device may receive a response from the memory system. Such operations may be similar to the operations described at block 508.

At block 616, the host device may read from one or more boot LUNs of the memory system at the higher speed supported by the PHY, such as HS-G4.

At block 618, an fDeviceInit operation may be performed, and an initialization of the memory system may be completed. Thus, the PHY configuration information may be read from a memory of the memory system, and the PHY may be configured to operate at a higher speed based on the PHY configuration information, before initialization of the memory system is complete. For example, in the method described with respect to FIG. 5, without the buffer containing PHY configuration information, the PHY may not operate at a maximum speed until after the fDeviceInit operation is complete, while use of a buffer containing PHY configuration information to update a configuration of the PHY as described with respect to FIG. 6 may allow the PHY to operate at a higher speed, such as HS-G4, even before initialization of the memory including the buffer is complete.

At block 620, a device query may be transmitted from the host device and received by the memory system, and the host device may receive a response from the memory system. Such operations may be similar to the operations described at block 508.

At block 622, the host device may proceed to read from all LUNs. For example, data may be read from all LUNs of the memory system at the highest supported speed. Thus, use of PHY configuration information stored in a buffer to patch a PHY to operate at a higher speed early in the booting process may reduce a time of the booting process.

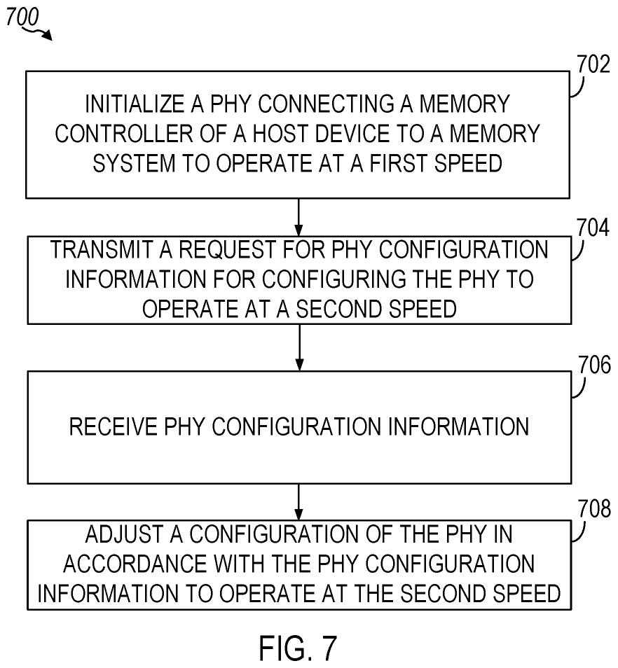

FIG. 7 is flow chart illustrating a method for updating a configuration of a PHY to operate at a high speed early in an initialization process by a host controller according to some embodiments of the disclosure. A method 700 includes, at block 702, initialization, by the host controller of a host device a PHY connecting the memory controller of the host device to a memory system to operate at a first speed. For example, the host device, the PHY and the memory system may be included in a SoC. An initialization process for the host device may include initialization of the PHY and the memory system. The memory system may, for example, be a UFS memory system including one or more flash memories. The initialization process may also be referred to as a booting process. The PHY may, for example, be initialized upon completion of power up and minimal initialization of the memory system to operate at a first speed. The first speed may, for example, be a low speed, such as a PWM-1 speed or HS-G1 speed. The initialization process may, for example, include a link startup process, also referred to as a link initialization process, for initializing a link between the memory controller of the host device and the memory system via the PHY. Such initialization may, for example, be performed by a PBL of the host device during a PBL stage of initialization of the host device.

At block 704, the memory controller of the host device may transmit a request for PHY configuration information for configuring the PHY to operate at a second speed. For example, the memory controller may transmit a request, via the PHY, to the memory system for PHY configuration information for configuring the PHY to operate at a second speed from a first buffer of the memory system. The PHY configuration information may, for example, include a PHY patch associated with a second speed, greater than the first speed. For example, the PHY configuration information may include higher gear parameters for reconfiguration of the PHY. As another example, the PHY configuration information may include one or more post-silicon updates to a PHY configuration, such as updates for increasing a speed of the PHY, patching one or more PHY bugs, optimizing the PHY for operation with a particular host device and/or memory system, or otherwise tuning PHY operation. For example, the PHY configuration information may include one or more PHY tuning parameters. The first buffer may, for example, be a SoC buffer stored on a flash memory of the memory system. The buffer may, for example, be a portion of a memory in the memory system, such as a flash memory allocated for use by the host device to store PHY configuration information and, in some embodiments, other information. Other information stored by the buffer may, for example, include other information for configuration of the host device and/or SoC, such as information for use by the host device before initialization of the memory system is complete. For example, other information stored by the buffer may include SoC or host configuration information for enabling or disabling hardware or software interfaces and/or adjusting other hardware or software configuration parameters. The buffer may, for example, include PHY configuration information for configuring the PHY to operate at one or more speeds greater than the first speed, such as HS-G2, HS-G3, HS-G4, HS-G5, or another higher speed. In some embodiments, the request may, for example, include a READ BUFFER command. Such a command may be used to access the information stored in the buffer before the host device is fully initialized and after the host device is fully initialized. A size of the buffer may, for example, be 4 kB. In some embodiments, the buffer may store one or more PHY patches for patching the PHY to operate at one or more higher speeds. In some embodiments, the request may specify a particular PHY patch to be retrieved from the buffer. For example, the request may specify a PHY patch for configuring the PHY to operate at a highest speed supported by a UFS version of the memory system. Such a request may, for example, be transmitted by a PBL of the host device during a PBL stage of initialization of the host device. In some embodiments, the buffer may be configured as read only, to prevent revision of the PHY configuration information. In some embodiments, the request may be transmitted following receipt of a first NOP IN from the memory system and prior to transmission of a first device query to the memory system.

In some embodiments, the buffer may be updated using a WRITE BUFFER command after the host device is fully initialized. For example, if a bConfigDescrLock variable is set to 00h, the memory system may process WRITE BUFFER commands targeting the buffer. In some embodiments, however, the buffer may be locked and may be read only. In such embodiments, the bConfigDescrLock variable may be set to a value of 01h, and the memory system, such as a memory controller of the memory system, may terminate received WRITE BUFFER commands targeting the buffer with a CHECK CONDITION STATUS with a SENSE KEY variable set to DATA PROTECT. In some embodiments, the buffer variables and commands may be variables and commands identified by the UFS standard.

At block 706, the memory controller of the host device may receive the PHY configuration information from the memory system. For example, the requested PHY configuration information may be received by the memory controller via the PHY connecting the memory controller of the host device to the memory system. The requested PHY configuration information may, for example, be received by a PBL of the host device during a PBL stage of initialization of the host device.

At block 708, the memory controller of the host device may adjust a configuration of the PHY in accordance with the PHY configuration information to operate at the second speed. For example, the memory controller may apply a patch of the configuration information to the PHY to adjust a configuration of the PHY such that the PHY begins to operate at the second, greater, speed. The memory controller may then proceed to communicate with the memory system via the PHY at the second, higher, speed. The configuration of the PHY may, for example, be adjusted by a PBL of the host device during a PBL stage of initialization of the host device. In some embodiments, the memory controller of the host device may be configured to complete initialization of the memory system, such as initialization of the flash memory including the buffer storing the PHY configuration information, following adjustment of the configuration of the PHY to operate at the second speed. For example, part or all of an fDeviceInit operation may be performed and completed after the configuration of the PHY is updated for operation of the PHY at the second speed. Thus, a configuration of a PHY may be updated to increase a speed of the PHY during a PBL phase of an initialization process, and the PHY may proceed to facilitate communication between the host device and the memory system at the greater speed during the PBL phase of the initialization process and during subsequent phases of the initialization process. Use of such a buffer may allow for post-silicon updates to facilitate enhanced PHY speeds without requiring additional boot read-only memory for the host device. Such a buffer may thus allow for an optimized booting process, reducing initialization time, allowing for storage of higher gear parameters, and reconfiguration of the PHY to operate at higher speeds during PBL and bootloader stages of initialization. Inclusion of the buffer on the memory of the memory system may allow for optimization of boot read-only memory of the host device. For example, instead of requiring a new die spin when read-only memory errors or inefficiency are found in a read-only memory of the host device, the buffer may store patches to ROM code for resolving errors and/or improving performance. Furthermore, such a buffer may be used to store one or more custom operations for one or more stages of initialization of the host device.

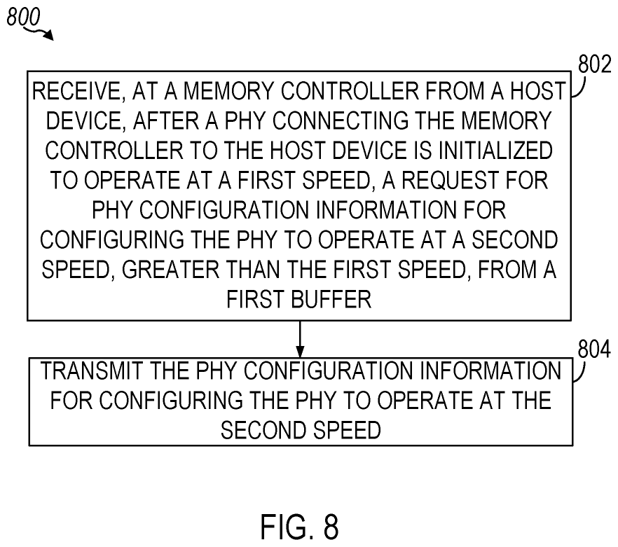

FIG. 8 is a flow chart illustrating a method 800 for updating a configuration of a PHY to operate at a high speed early in an initialization process by a flash memory system according to some embodiments of the disclosure. The memory system may, for example, be connected to a memory controller of the host device via a PHY. The method 800 may be performed by a memory controller of the flash memory system. The method 800 includes, at block 802, receiving, by a memory controller of the memory system from a host device, after a PHY connecting the memory controller to the host device is initialized to operate at a first speed, a request for PHY configuration information for configuring the PHY to operate at a second speed, greater than the first speed, from a first buffer. The request may, for example, be the request described with respect to block 704 of FIG. 7, and the buffer may be a buffer storing PHY configuration information, such as one or more PHY patches, as described with respect to FIG. 7.

At block 804, the memory controller may transmit a the PHY configuration information to the host device. For example, the memory controller of the memory system may transmit the requested PHY configuration information for updating the PHY to a memory controller of the host device, as described with respect to block 706 of FIG. 7. Thus, the memory controller may receive the request and may transmit the PHY configuration information before the memory system is fully initialized, such as before an fDeviceInit operation for the memory system is complete. The host device may then adjust a configuration of the PHY in accordance with the PHY configuration information such that the PHY is configured to operate at the second speed. The host device may then proceed to communicate with the memory controller of the memory system via the PHY at the second speed.

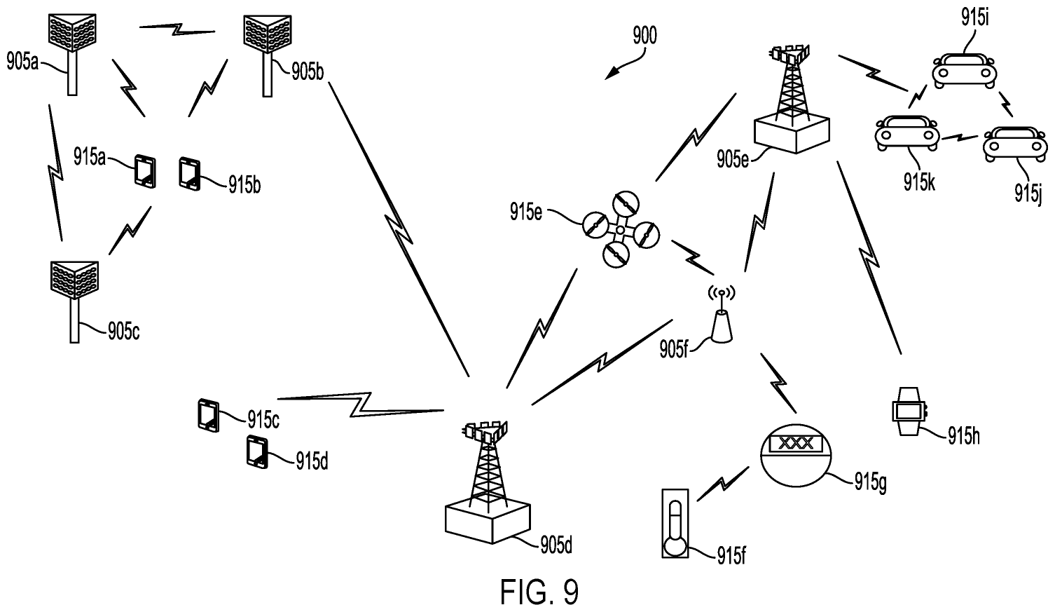

Operations of method 500, method 600, method 700, or method 800 may be performed by a UE, such as a UE described with reference to FIG. 9. For example, example operations (also referred to as “blocks”) of method 500, method 600, method 700, or method 800 may enable UE 915 to support greater user data confidentiality. FIG. 9 is a block diagram illustrating details of an example wireless communication system according to one or more aspects. The wireless communication system may include wireless network 900. Wireless network 900 may, for example, include a 5G wireless network. As appreciated by those skilled in the art, components appearing in FIG. 9 are likely to have related counterparts in other network arrangements including, for example, cellular-style network arrangements and non-cellular-style-network arrangements (e.g., device to device or peer to peer or ad hoc network arrangements, etc.).

Wireless network 900 illustrated in FIG. 9 includes a number of base stations 905 and other network entities. A base station may be a station that communicates with the UEs and may also be referred to as an evolved node B (eNB), a next generation eNB (gNB), an access point, and the like. Each base station 905 may provide communication coverage for a particular geographic area. In 3GPP, the term “cell” may refer to this particular geographic coverage area of a base station or a base station subsystem serving the coverage area, depending on the context in which the term is used. In implementations of wireless network 900 herein, base stations 905 may be associated with a same operator or different operators (e.g., wireless network 900 may include a plurality of operator wireless networks). Additionally, in implementations of wireless network 900 herein, base station 905 may provide wireless communications using one or more of the same frequencies (e.g., one or more frequency bands in licensed spectrum, unlicensed spectrum, or a combination thereof) as a neighboring cell. In some examples, an individual base station 905 or UE 915 may be operated by more than one network operating entity. In some other examples, each base station 905 and UE 915 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 9, base stations 905d and 905e are regular macro base stations, while base stations 905a-905c are macro base stations enabled with one of 3 dimension (3D), full dimension (FD), or massive MIMO. Base stations 905a-905c take advantage of their higher dimension MIMO capabilities to exploit 3D beamforming in both elevation and azimuth beamforming to increase coverage and capacity. Base station 905f is a small cell base station which may be a home node or portable access point. A base station may support one or multiple (e.g., two, three, four, and the like) cells.

Wireless network 900 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 915 are dispersed throughout the wireless network 900, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 915, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a flying device, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 915a-915d of the implementation illustrated in FIG. 9 are examples of mobile smart phone-type devices accessing wireless network 900. A UE may also be a machine specifically configured for connected communication, including machine type communication (MTC), enhanced MTC (eMTC), narrowband IoT (NB-IoT) and the like. UEs 915e-915k illustrated in FIG. 9 are examples of various machines configured for communication that access wireless network 900.

A mobile apparatus, such as UEs 915, may be able to communicate with any type of the base stations, whether macro base stations, pico base stations, femto base stations, relays, and the like. In FIG. 9, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 900 may occur using wired or wireless communication links.

In operation at wireless network 900, base stations 905a-905c serve UEs 915a and 915b using 3D beamforming and coordinated spatial techniques, such as coordinated multipoint (CoMP) or multi-connectivity. Macro base station 905d performs backhaul communications with base stations 905a-905c, as well as small cell, base station 905f. Macro base station 905d also transmits multicast services which are subscribed to and received by UEs 915c and 915d. Such multicast services may include mobile television or stream video, or may include other services for providing community information, such as weather emergencies or alerts, such as Amber alerts or gray alerts.

Wireless network 900 of implementations supports mission critical communications with ultra-reliable and redundant links for mission critical devices, such UE 915e, which is a aeronautical vehicle. Redundant communication links with UE 915e include from macro base stations 905d and 905e, as well as small cell base station 905f. Other machine type devices, such as UE 915f (thermometer), UE 915g (smart meter), and UE 915h (wearable device) may communicate through wireless network 900 either directly with base stations, such as small cell base station 905f, and macro base station 905e, or in multi-hop configurations by communicating with another user device which relays its information to the network, such as UE 915f communicating temperature measurement information to the smart meter, UE 915g, which is then reported to the network through small cell base station 905f. Wireless network 900 may also provide additional network efficiency through dynamic, low-latency TDD communications or low-latency FDD communications, such as in a vehicle-to-vehicle (V2V) mesh network between UEs 915i-915k communicating with macro base station 905e.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANS.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In one or more aspects, techniques for supporting data storage and/or data transmission, may include additional aspects, such as any single aspect or any combination of aspects described below or in connection with one or more other processes or devices described elsewhere herein. In one aspect, an electronic device, such as a UE, may be an apparatus such as a host device that includes a memory controller configured to couple via a physical interface (PHY) to a memory system, in which the memory system may be integrated with the host device or externally coupled to the host device. The memory system may include a memory controller coupled to a memory system through a first channel and configured to access data stored in the memory system through the first channel and coupled to a host device through a first interface, such as a PHY, and configured to communicate with the host device over the first interface. The operations may be executed as part of an initialization operation, a read operation or a write operation.

In a first aspect, the memory controller of the memory system may be configured to perform operations including receiving, from the host device, after the PHY is initialized to operate at a first speed, a request for PHY configuration information for configuring the PHY to operate at a second speed, greater than the first speed, from a first buffer of the memory module and transmitting the PHY configuration information to the host device.

In a second aspect, in combination with the first aspect, the first buffer is located in a flash memory of the memory module.

In a third aspect, in combination with one or more of the first aspect or the second aspect, transmitting the PHY configuration information is performed before initialization of the flash memory is complete

In a fourth aspect, in combination with one or more of the first aspect through the third aspect, the PHY is initialized to operate at the first speed during a link initialization stage of initialization of the host device.

In a fifth aspect, in combination with one or more of the first aspect through the fourth aspect, the PHY configuration information comprises a PHY patch associated with the second speed.

In a sixth aspect, in combination with one or more of the first aspect through the fifth aspect, the buffer stores a plurality of PHY patches associated with a plurality of speeds.

In a seventh aspect, in combination with one or more of the first aspect through the sixth aspect, the first buffer is configured as read-only.

In an eighth aspect, the memory controller of the host device may be configured to perform operations including initializing the PHY to operate at a first speed, receiving PHY configuration information for configuring the PHY to operate at a second speed, greater than the first speed, from a first buffer of the memory system, and adjusting a configuration of the PHY in accordance with the PHY configuration information to operate at the second speed.

In a ninth aspect, in combination with the eighth aspect, the first buffer is located in a flash memory of the memory system.

In a tenth aspect, in combination with one or more of the eighth aspect through the ninth aspect, the memory controller is further configured to complete initialization of the flash memory after adjusting the configuration of the PHY.

In an eleventh aspect, in combination with one or more of the eighth aspect through the tenth aspect, initializing the PHY to operate at the first speed comprises completing a link initialization stage of initialization of the host device.

In a twelfth aspect, in combination with one or more of the eighth aspect through the eleventh aspect, the memory controller of the memory system may be further configured to perform operations including transmitting, after initializing the PHY to operate at the first speed, a request for the PHY configuration information to the memory system.

In a thirteenth aspect, in combination with one or more of the eighth aspect through the twelfth aspect, the PHY configuration information comprises a PHY patch associated with the second speed, and wherein adjusting the configuration of the PHY comprises applying the PHY patch.

In a fourteenth aspect, in combination with one or more of the eighth aspect through the thirteenth aspect, the buffer stores a plurality of PHY patches associated with a plurality of speeds.

In a fifteenth aspect, in combination with one or more of the eighth aspect through the fourteenth aspect, the first buffer is configured as read-only.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4A-E, 5, 6, 7, or 8 may be combined with one or more blocks (or operations) described with reference to another of the figures. For example, one or more blocks (or operations) of FIG. 1 may be combined with one or more blocks (or operations) of FIG. 3. As another example, one or more blocks associated with FIG. 1 may be combined with one or more blocks (or operations) associated with FIGS. 4A-E, 5, 6, 7, or 8. Additionally, or alternatively, one or more operations described above with reference to FIGS. 1-3 may be combined with one or more operations described with reference to FIGS. 4-8.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus, comprising:
a memory controller of a host device configured to couple the host device to a memory system through a physical layer interface (PHY), the memory controller configured to perform operations including:
initializing the PHY to operate at a first speed;
receiving PHY configuration information for configuring the PHY to operate at a second speed, greater than the first speed, from a first buffer of the memory system; and
adjusting a configuration of the PHY in accordance with the PHY configuration information to operate at the second speed.

2. The apparatus of claim 1, wherein the first buffer is located in a flash memory of the memory system.

3. The apparatus of claim 2, wherein the memory controller is further configured to complete initialization of the flash memory after adjusting the configuration of the PHY.

4. The apparatus of claim 3, wherein initializing the PHY to operate at the first speed comprises completing a link initialization stage of initialization of the host device.

5. The apparatus of claim 1, wherein the memory controller is further configured to perform operations including:
transmitting, after initializing the PHY to operate at the first speed, a request for the PHY configuration information to the memory system.

6. The apparatus of claim 1, wherein the PHY configuration information comprises a PHY patch associated with the second speed, and wherein adjusting the configuration of the PHY comprises applying the PHY patch.

7. The apparatus of claim 6, wherein the buffer stores a plurality of PHY patches associated with a plurality of speeds.

8. The apparatus of claim 1, wherein the first buffer is configured as read-only.

9. A method, comprising:
initializing, by a memory controller of a host device, a physical interface (PHY) for connecting the host device to a memory system to operate at a first speed;
receiving PHY configuration information for configuring the PHY to operate at a second speed, greater than the first speed, from a first buffer of the memory system; and
adjusting, by the memory controller, a configuration of the PHY in accordance with the PHY configuration information to operate at the second speed.

10. The method of claim 9, wherein the first buffer is located in a flash memory of the memory system.

11. The method of claim 10, further comprising completing initialization of the flash memory after adjusting the configuration of the PHY.

12. The method of claim 11, wherein initializing the PHY to operate at the first speed comprises completing a link initialization stage of initialization of the host device.

13. The method of claim 9, further comprising:
transmitting, after initializing the PHY to operate at the first speed, a request for the PHY configuration information to the memory system.

14. The method of claim 9, wherein the PHY configuration information comprises a PHY patch associated with the second speed, and wherein adjusting the configuration of the PHY comprises applying the PHY patch.

15. The method of claim 14, wherein the buffer stores a plurality of PHY patches associated with a plurality of speeds.

16. The method of claim 9, wherein the first buffer is configured as read-only.

17. An apparatus, comprising:
a memory controller:
coupled to a memory module through a first channel and configured to access data stored in the memory module through the first channel; and
coupled to a host device through a first physical interface (PHY) and configured to communicate with the host device over the first PHY,
the memory controller configured to perform operations comprising:
receiving, from the host device, after the PHY is initialized to operate at a first speed, a request for PHY configuration information for configuring the PHY to operate at a second speed, greater than the first speed, from a first buffer of the memory module; and
transmitting the PHY configuration information to the host device.

18. The apparatus of claim 17, wherein the first buffer is located in a flash memory of the memory module.

19. The apparatus of claim 18, wherein transmitting the PHY configuration information is performed before initialization of the flash memory is complete.

20. The apparatus of claim 19, wherein the PHY is initialized to operate at the first speed during a link initialization stage of initialization of the host device.

21. The apparatus of claim 17, wherein the PHY configuration information comprises a PHY patch associated with the second speed.

22. The apparatus of claim 21, wherein the buffer stores a plurality of PHY patches associated with a plurality of speeds.

23. The apparatus of claim 17, wherein the first buffer is configured as read-only.

24. A method, comprising:
receiving, at a memory controller from a host device, after a physical interface (PHY) connecting the memory controller to the host device is initialized to operate at a first speed, a request for PHY configuration information for configuring the PHY to operate at a second speed, greater than the first speed, from a first buffer of a memory module coupled to the memory controller; and
transmitting, by the memory controller, the PHY configuration information to the host device.

25. The method of claim 24, wherein the first buffer is located in a flash memory of the memory module.

26. The method of claim 25, wherein transmitting the PHY configuration information is performed before initialization of the flash memory is complete.

27. The method of claim 26, wherein the PHY is initialized to operate at the first speed during a link initialization stage of initialization of the host device.

28. The method of claim 24, wherein the PHY configuration information comprises a PHY patch associated with the second speed.

29. The method of claim 28, wherein the buffer stores a plurality of PHY patches associated with a plurality of speeds.

30. The method of claim 24, wherein the first buffer is configured as read-only.
